(19) United States
(12) Patent Application Publication
(10) Pub. No.: US 2026/0030587 A1
(43) Pub. Date: Jan. 29, 2026

(54) METHOD FOR PROVIDING A METERING DEVICE FOR BULK GOODS, METHOD FOR OBTAINING A RECOMMENDATION FOR A CONFIGURATION OF A METERING DEVICE FOR BULK GOODS, AND DEVICES FOR PROCESSING DATA

(71) Applicant: Qlar Europe GmbH, Darmstadt (DE)

(72) Inventors: Viktor RAIS, Darmstadt (DE); Herman DE JONG, Darmstadt (DE)

(73) Assignee: Qlar Europe GmbH, Darmstadt (DE)

(21) Appl. No.: 19/343,422

(22) Filed: Sep. 29, 2025

Related U.S. Application Data
(63) Continuation of application No. PCT/EP2024/058038, filed on Mar. 26, 2024.

(30) Foreign Application Priority Data
Mar. 27, 2023 (DE) 10 2023 107 572.1

(51) Int. Cl. G06Q 10/087; G06T 7/00; G06T 7/73; G06V 20/52

(52) U.S. Cl. CPC G06Q 10/087; G06T 7/0004; G06T 7/73; G06V 20/52

(57) ABSTRACT

A method for ascertaining at least one configuration of a metering device for buik goods to be metered. A method for obtaining a recommendation for a configuration of a metering device for buik goods to be metered, and devices for processing data are also provided.

This nonprovisional application is a continuation of International Application No. PCT/EP2024/058038, which was filed on Mar. 26, 2024, and which claims priority to German Patent Application No. 10 2023 107 572.1, which was filed in Germany on Mar. 27, 2023, and which are both herein incorporated by reference.

### FIELD OF THE INVENTION

The present invention relates to a method for providing a metering device for bulk goods to be metered, a method for obtaining a recommendation for a configuration of a metering device for bulk goods to be metered, and devices for processing data.

### DESCRIPTION OF THE BACKGROUND ART

Metering devices for metering bulk goods consist of a plurality of components that must be suitably selected and coordinated with one another depending on the bulk goods to be metered. To design a metering device, it has often been necessary to examine the physical properties of the bulk goods to be metered in the laboratory and to test its interaction with different embodiments of the mechanical components and with various settings of the operating parameters in experimental setups. However, reproducible and therefore reliable results from such analyses are only possible with time-consuming and cost-intensive measures that additionally require the use of specially trained personnel.

### SUMMARY OF THE INVENTION

It is therefore an object of the present invention to overcome the described disadvantages of the prior art and, in particular, to provide means with which, against the background of bulk goods to be metered, a configuration of a metering device suitable for metering the respective bulk goods can be obtained in a simple yet reliable manner.

Configuration may refer, on the one hand, to the selection of a metering device suitable for the material to be metered and, on the other hand, to the selection or adjustment of the operating parameters and components of the metering device. Often, it is first necessary to decide which type of metering device, particularly with regard to the conveying devices used, is suitable for the relevant bulk goods. Pneumatic metering devices (dilute phase conveying, dense phase conveying, etc.) and mechanical metering devices with different discharge devices such as belt conveyors, screw conveyors, rotary valves, etc. are available. According to the method of the invention, in order to determine a configuration of a metering device for bulk goods to be metered, a first image of a sample of the bulk goods is created and, based on the data of the first image, a type of metering device and/or a corresponding configuration of the metering device for the bulk goods is determined.

The invention is therefore based on the surprising finding that taking a sample of bulk goods to be metered allows to derive information about the respective bulk goods that at least implicitly relates to one or more properties of the bulk goods which influence the metering behavior of the bulk goods. Based on this information, the appropriate metering device and/or components and/or operating parameters of a metering device suitable for metering the respective bulk goods can then be determined and output as a configuration of a metering device.

Complex analyses of the bulk goods with regard to their physical properties can thus be eliminated or at least reduced. This makes it possible to determine a suitable configuration of a metering device particularly quickly against the background of bulk goods to be metered.

In this context, it has been shown that the configuration proposal obtained with the proposed method can sometimes be superior to that of an expert. Apparently, the metering behavior of the bulk goods can sometimes be described even better using the information obtained from the recordings than with conventional parameters, which have previously been determined by complex sample tests on complicated test rigs, for example with regard to physical parameters of the bulk goods.

In this respect, the method also advantageously makes it possible to operate an existing metering device alternately with different bulk goods without great effort. This is because no material-specific background knowledge is necessary to determine the configurations. This can increase both the utilization of the metering device and thus the economic efficiency, as well as the operational reliability.

Above all, the proposed method makes it possible for even a non-technical person to determine a suitable configuration of a metering device for bulk goods to be metered, in order to then, for example, select the metering device itself, components of a metering device, and/or replace components of an existing metering device based on a corresponding suggestion. Advantageously, the configuration of a metering device can be fully or partially automated using the method, in particular, with regard to the setting of operating parameters.

The proposed method can also be easily applied to existing metering devices, which, for example, need to be adapted or checked with regard to their configuration against the background of bulk goods to be metered. In fact, it is basically sufficient to have the bulk goods sample available and to evaluate it in an appropriate manner. This means that the method can be used with a wide variety of different metering devices and proves to be extremely flexible.

Examples of advantageous bulk goods are rock, building materials, in particular, topsoil, sand, gravel, and/or cement; raw materials, in particular ore, coal, clay, and/or road salt; foodstuffs, in particular, grain, sugar, salt, coffee and/or flour; and/or powdered goods, in particular pigments, fillers, granules, and/or pellets.

The type of bulk goods may, for example, be one of the following types of bulk goods: dust, powder, flour, grains, granules, meal, lumps, pellets, and/or other.

The method is advantageously computer-implemented.

The process can advantageously be provided as a cloud service. This means that no extensive data processing needs to take place at the location of the metering device to be configured.

The obtaining of a recording advantageously comprises the obtaining of data, in particular image data, of the recording. For example, the data represents pixel values of the recording. This data can be received in raw format, in a pre-processed image format, and/or from a suitable light-sensitive sensor.

When the present application refers to a configuration of a metering device for bulk goods to be metered, this preferably means the specification of a type designation and/or a unique identifier of at least one component, in particular a mechanical component, to be selected for the metering device, and/or at least one setting for an operating parameter of the metering device.

If in the present application the configuration is determined “based on” certain data, this should advantageously be understood to mean that the configuration would not be determinable without such data. In this case, such data (which may be referred to as source data) can advantageously be subjected to one or more data processing steps in order to obtain processed data. Within these data processing steps, such data can, for example, be evaluated, further processed, and/or merged with other data. With the help of such data, further information can also be obtained, in particular from other sources, such as databases, and may be available, for example, as interim results. Within data processing steps, the additional information may be subjected to further data processing steps in addition to or instead of the source data and/or processed data, including processing with other source data. The latter means, more generally speaking, that several different source data can be present, “based on” which the configuration is determined, wherein these can each be processed individually and, at a certain processing step, two or more different source data, possibly each already in processed form, can be combined and optionally used as input data for subsequent data processing.

It may also be provided that the method comprises that the configuration of a metering device for the bulk goods can be determined via a suggestion module, that the data of the first recording is included in the determination of the configuration via the suggestion module, and/or that, via a first evaluation module, a first property of the bulk goods and/or an identifier of the bulk goods is determined based on the data of the first recording, and wherein the first bulk goods property and/or the identifier is included in the determination of the configuration via the suggestion module.

The identifier may, for example, be a unique identifier (such as an alphanumeric string, a name, or a chemical formula) of the bulk goods. Advantageously, further information on the bulk goods, which is pre-stored, for example, can be determined on the basis of the identifier using a database. Information, such as material specifications of the bulk goods, can then be retrieved from a database using the identifier for the bulk goods. This will be discussed in more detail below.

Preferably, several initial bulk goods properties can be determined and optionally included in the determination of the configuration. In one embodiment, the (at least one) first bulk goods property is determined using image processing and evaluation methods based on the first recording.

The suggestion module can be implemented, for example, in software, in hardware, or in a combination of both. The suggestion module may alternatively or additionally comprise a memory, a processor, a receiving device (for example, to receive the recording), a transmitting device (for example, to send a generated signal to another entity), or any combination thereof. Alternatively or additionally, the suggestion module may provide and/or make available and/or comprise everything that it comprises, in particular, all the resources necessary for this purpose, for example, in the form of software and/or hardware resources.

The first evaluation module can be implemented, for example, in software, in hardware, or in a combination of both. The first evaluation module may alternatively or additionally comprise a memory, a processor, a receiving device (for example, to receive the recording), a transmitting device (for example, to send a generated signal to another entity), or any combination thereof. The first evaluation module can alternatively or additionally provide and/or make available and/or comprise everything that it comprises, such as, in particular, all the resources necessary for this purpose, for example, in the form of software and/or hardware resources.

The suggestion module can comprise the first evaluation module. The first evaluation module and the suggestion module can preferably also be identical and thus a common module.

The two modules can be operated spatially separated from each other. This is advantageous when the two modules have different requirements for hardware and/or software resources, and, thus, the module with more computationally intensive operations can be operated in an environment with sufficient hardware and/or software resources. In this case, the modules can exchange data with each other, for example, via a data connection.

The data of the first recording can represent the first bulk goods property and/or the configuration of the metering device represents the output data of the suggestion module. Further input and/or output data, in particular, those described elsewhere in the application, are possible.

Preferably, the output data of a module can be obtained by the respective module at least in part by processing at least the input data of the respective module, i.e. by evaluating, analyzing, and/or converting it into new data.

Alternatively or additionally, it may also be provided that the method can comprise that, starting from the identifier, information, in particular comprising a first bulk goods property, relating to bulk goods assigned to the identifier is retrieved from a database and included in the determination of the configuration via the suggestion module.

The additional information allows a configuration to be determined even more reliably and securely. This also makes it possible to take into account information relating to the bulk goods that cannot be directly obtained from the data of the recording, but which can be obtained from other sources (such as the database). For this purpose, the identifier can be used as a connecting element (relation). This means that the information is obtained based on the data from the recording and with the further use of other resources (such as databases, etc.).

The retrieved information may, for example, be or have a property, such as a first bulk goods property, of the bulk goods.

In this case, the information is advantageously obtained using the identifier, for example, retrieved from the database.

Thus, in an example, additional information about the bulk goods (in particular, based on the identifier from a database) can be determined and included in the determination of the configuration (in particular, at least partially via the suggestion module).

Preferably, the information concerns material properties of the bulk goods. Based on the material properties, the suitability of the bulk goods for use in a metering device with a specific equipment, for example, with regard to mechanical components and/or the setting of operating parameters, can be advantageously assessed. Therefore, it is advantageous if, starting from the data of the first recording and with the help of the identifier, one or more material properties are obtained and included in the determination of the configuration.

The retrieved information can advantageously be supplied to an entity and/or provided to a user, for example, via a user interface, such as a screen. This means that in addition to the configuration, a justification can also be provided, for example, as to the circumstances under which the configuration was made as proposed.

At least the retrieved information can represent input data of the suggestion module. Further input and/or output data, in particular, those described elsewhere in the application, is possible.

The method can comprise obtaining a data set which represents a second property of the bulk goods, wherein (i) based on the data set obtained, a configuration of a metering device for the bulk goods is determined via the suggestion module, and/or (ii) the data set is included in the determination of the configuration via the suggestion module.

The data obtained is used in addition to the data from the first recording to determine the configuration. In this case, the data from the first recording and the data set can be processed together to obtain a common intermediate variable, which in turn is further processed to determine the configuration, or a first intermediate variable is obtained from the image data and a second intermediate variable is obtained from the data set, and the first and second intermediate variables are further processed to determine the configuration.

The data set can, for example, represent and/or encode one or more properties of the bulk goods. Alternatively or additionally, the data set could also represent a character sequence, preferably binary, wherein each position represents a property of the bulk goods. An example of such a character sequence is the binary sequence 0101011101, ten bulk goods properties (for example, “sticky”, “electrostatic”, “granular”, . . . ) are each encoded to indicate the presence (“1”) or the absence (“0”) of the respective property for the bulk goods.

The obtained data set can represent input data of the suggestion module. Other input and/or output data described elsewhere in the application is possible.

The data volume can be obtained by user input, in particular, via a human-machine interface.

The method can comprise obtaining a second recording of the sample of the bulk goods, and wherein (i) based on the data of the second recording, the configuration of a metering device for the bulk goods is determined via the suggestion module, and/or (ii) the data of the second recording is included in the determination of the configuration via the suggestion module, wherein preferably (i) via the first evaluation module, a first property of the bulk goods and/or an identifier of the bulk goods is determined based on the data of the first and second recordings, and/or (ii) via a second evaluation module, a second property of the bulk goods is determined based on the data of the first and/or second recordings and is included in the determination of the configuration via the suggestion module.

The data from the second recording can, therefore, be used in addition to the data from the first recording (and, if applicable, the obtained data set) to determine the configuration.

Preferably, the data from the first recording is not used to determine the second property. For example, the second property can then be determined based on the data of the second recording in such a way that the data of the second recording, but not the data of the first recording, is fed to the data input of the respective evaluation module. Preferably, further input data can be provided, which is not the data of the first recording.

It is also advantageously possible to determine the first bulk goods property and/or the second bulk goods property using the data from the first and second recordings. For this purpose, the data from the first and second recording can be fed to the data input of the respective evaluation module. Preferably, further input data can be provided.

The first and/or second property determined here can be advantageously a different property than the property explained above, represented by the obtained data set.

The second evaluation module may be implemented, for example, in software, in hardware, or in a combination of both. The second evaluation module may alternatively or additionally comprise a memory, a processor, a receiving device (for example, to receive the recording), a transmitting device (for example, to send a generated signal to another entity), or any combination thereof. The second evaluation module may alternatively or additionally provide and/or make available and/or comprise everything that it has, such as, in particular, all the resources necessary for this purpose, for example, in the form of software and/or hardware resources.

The suggestion module can comprise the second evaluation module. The second evaluation module and the suggestion module may preferably also be identical and thus form a common module.

The two modules can be operated spatially separated from each other. This is advantageous when the two modules have different requirements for hardware and/or software resources, and, thus, the module with more computationally intensive operations can be operated in an environment with sufficient hardware and/or software resources. In this case, the modules can exchange data with each other, for example, via a data connection.

It is also possible that the first evaluation module, the second evaluation module, and the suggestion module are identical and/or that the first evaluation module and the second evaluation module are identical.

At least the data of the second recording can represent input data of the first evaluation module. Further input and/or output data, in particular, those described elsewhere in the application, is possible.

At least the data of the first and/or second recording can represent input data and/or the second property represents output data of the second evaluation module. Further input and/or output data, in particular, those described elsewhere in the application, is possible.

The data of the second recording and/or the second property can represent input data of the suggestion module. Further input and/or output data, in particular, those described elsewhere in the application, is possible.

It may also be provided that (i) the first recording and the second recording can be carried out, preferably simultaneously or sequentially, from different perspectives, and/or (ii) the bulk goods sample is in a first sample configuration during the first recording and the bulk goods sample is in a second sample configuration during the second recording, wherein the bulk goods sample is transferred from the first sample configuration to the second sample configuration between the two recordings.

For example, the first and the second recordings may be taken with one and the same recording device, and the position and/or orientation of the recording device may be changed between the recordings in order to record the two recordings one after the other from different perspectives.

For example, the first and second recordings may be taken with different recording devices, wherein the recording devices have different positions and/or orientations. This makes it particularly advantageous to take both recordings simultaneously from different perspectives.

The perspectives of the two recording may be identical.

A sample configuration can be preferably understood to mean the type and manner of a spatial arrangement of the bulk goods of the sample, in particular, under existing boundary conditions, such as existing environmental conditions, and/or the conditions of the formation of material accumulations (e.g. clumps) within the arrangement.

For example, bulk goods sample may be piled up on a flat surface from a feed pipe from a certain height. The way in which the bulk sample forms a heap can then be understood as sample configuration. This sample configuration may differ from another sample configuration obtained when the bulk sample is piled onto the flat base from a different height. Instead of the height, the angle of inclination of the base may also be changed.

The first and second sample configurations can be two differently formed heaps of the bulk goods sample and/or at least one parameter of the ambient conditions, such as ambient temperature, air humidity and/or ambient pressure, of the bulk goods sample is changed between the first and second sample configuration.

Preferably, the bulk goods in both sample configurations can be in a state of equilibrium with the respective existing physical environmental conditions.

For example, a heap may be formed with the sample at two different ambient temperatures (preferably using the same procedure in each case). The different formation of the heap in the two cases represents the different sample configurations. In this case, the bulk goods of the sample are always at the respective ambient temperature, i.e. in an equilibrium state.

Another possible environmental condition is the inclination of the base (also mentioned above), on which the bulk goods sample is piled up.

The method can comprise evaluating and/or analyzing the data of the first and/or second recording using methods of digital recording analysis in the field of machine learning, in particular, in order to determine the first property, the second property, the identifier, and/or the configuration.

Advantageously, a digital recording analysis can be carried out using machine learning methods. For this purpose, a machine learning model may be trained on training data that is of the type of input data expected later, each associated with expected output data, and the trained model may be used to calculate output data that represents the respective specific information or other information based on the respective input data.

Therefore, the suggestion module may execute corresponding methods, in particular, on at least the data of the first and/or second recording, in order to determine the configuration.

Therefore, the first evaluation module may execute corresponding methods on the data of the first and/or second recording in order to determine, for example, the first property of the bulk goods, the second property of the bulk goods, and/or the identifier.

Therefore, for example, the second evaluation module may execute corresponding methods on the data of the first and/or second recording in order to determine the first and/or second property of the bulk goods.

The method can comprise obtaining a metering parameter and, based on the metering parameter, determining a configuration of a metering device for the bulk goods via the suggestion module.

The metering parameter can be used in addition to the data from the first recording (and, if applicable, the amount of data obtained and/or the data from the second recording) to determine the configuration.

For example, a maximum speed and/or a minimum dimension of the discharge element of the metering device may be specified for specific bulk goods (in particular the bulk goods to be metered). Therefore, the configuration may be determined against the background of corresponding restrictions, so that configurations that have higher speeds and/or a discharge device that does not meet the minimum dimensions are not determined.

The metering parameter may, for example, represent a characteristic parameter of the metering device. Examples of this are target, actual, maximum, and/or minimum values of an operating parameter. When determining the configuration, the performance of the metering device may therefore be advantageously taken into account. For example, the configuration can be determined against the background of specific bulk goods (which may be represented by the identifier discussed above) and taking into account the metering parameter.

At least the metering parameter can represent input data of the suggestion module. Further input and/or output data, in particular, those described elsewhere in the application, is possible.

A control signal representing the one determined configuration can be generated and fed to an entity as a configuration recommendation and/or output to a user on a human-machine interface, such as a screen, and/or that a metering device is configured based on the determined configuration.

The control signal advantageously makes it possible to provide an entity with information about the determined configuration. For example, the entity may be a higher-level metering device monitoring system and/or a metering device management system. Alternatively or additionally, the control signal may be sent to the entity to initiate monitoring of the metering device and/or for documentation purposes. In this way, a configuration may advantageously be maintained continuously even during ongoing operation of the metering device—particularly against the background of the bulk goods and/or changing operating parameters—and can be optionally updated or compared with the current configuration.

The entity may be the metering device for which the configuration can be determined or parts thereof, such as a motor or its motor control. The entity may, for example, also be a device different from the metering device.

The control signal may be an analog or digital signal. Alternatively or additionally, the control signal may also be a command within a software application.

It may also be provided that configurations and status data of metering devices and/or bulk goods data for the bulk goods metered with the metering devices can be received from a cloud-based computer and taken into account in the suggestion module when determining the configuration, wherein a provisionally determined configuration is validated on the basis of the received configurations, status data, and/or bulk goods data and is adjusted, if the provisionally determined configuration does not correspond to a defined quality standard.

In this way, information on the configuration, status data, and the bulk materials metered with metering devices in productive use may be obtained and advantageously used as feedback information when determining the configuration. In this way, information from productive use may be advantageously taken into account in the decision for a configuration. Preferably, a data set comprising configuration, status data, and bulk goods data is obtained for each pairing of a metering device and the bulk goods metered with it.

If, for example, in a particular configuration the metering process of particular bulk goods frequently (for example, in more than 10%, more than 30%, more than 50%, or more than 70% of cases) leads to a status code representing an impairment of the operation of the respective metering device, such a combination of configuration and bulk goods may be avoided and no longer be determined as a configuration in the method.

Another particularly advantageous feature is the ability to use the feedback information to check a determined configuration. For example, a configuration of a metering device may first be determined as a preliminary configuration for bulk goods, and this determined preliminary configuration is then verified using received feedback information. If it is then determined that the combination of preliminary configuration and bulk goods frequently (for example, in more than 10%, more than 30%, more than 50%, or more than 70% of cases) leads to a status code representing an impairment of the operation of the metering device, the preliminary configuration may advantageously be adapted and this adapted configuration can be determined as the configuration, or optionally a new preliminary configuration can be determined.

The determined configuration can be compared with a current configuration of a metering device used for metering the bulk goods and, depending on the result of the comparison, a control signal is generated which is fed as a control and/or regulating signal to the metering device and/or to an entity different from the metering device.

In this way, the operation of a metering device may be made more reliable and safer, since the determined configuration may be used to monitor the metering device and its metering process. If the configuration determined for the metering device deviates from the current configuration of the metering device, a corresponding control signal may be generated.

The method is therefore particularly suitable for monitoring the use of bulk goods during a metering process of a metering device. In this way, the configuration determined on the basis of bulk goods to be metered may be compared with the current configuration of the metering device and, optionally, if deviations are detected that are, in particular, not compatible with a defined or definable quality characteristic, an alarm signal may be generated. In this way, bulk goods to be metered that are not suitable for metering with the metering device in the current configuration may be detected. The alarm signal can be used to notify operating and/or monitoring personnel and optionally request action and/or abort an ongoing metering process.

It is also advantageously possible to continuously monitor the bulk goods fed to a metering device and to propose a new configuration for the metering device in question and/or to abort an ongoing metering process if the properties of the bulk goods have changed and therefore the existing configuration of the metering device no longer meets defined quality criteria. This allows the method to further improve the safety and reliability of the metering process.

Above all, in order to achieve this increase in safety, no structural changes need to be made to the respective metering device. Ultimately, it is sufficient to at least maintain the recording of the bulk goods. This means that the method may be used with a wide variety of metering devices, including existing ones, and proves to be extremely flexible.

By monitoring the bulk goods to be metered in this way, incorrect filling of a metering device can be avoided or detected at an early stage. In this way, critical situations, including production downtime, may be avoided more reliably than before. Metering processes that are unmanned and/or remotely controlled may also be monitored better and more reliably, thus avoiding or at least limiting expensive production errors.

In this respect, the method also makes it particularly advantageous to operate an existing metering device safely and reliably with different bulk goods without great effort. For example, in one embodiment, an automatic reconfiguration of the metering device may be provided based on the determined configuration. This increases the utilization of the metering device and thus the economic efficiency and may also increase operational reliability.

In addition, the corresponding monitoring of a metering device may be fully or partially automated using the method, thus further reducing or complete elimination of the susceptibility to errors otherwise caused by a human operator.

Preferably, the control signal can be fed to a motor, in particular, a motor controller of the motor, of the metering device, wherein a movement of a discharge element of the metering device can preferably be carried out via the motor. This means that a metering process may be advantageously influenced, for example, started or stopped, using the control signal.

A reference object can be recognizable in the first recording and/or the second recording, wherein the reference object has defined dimensions and/or patterns and/or is used to determine a distance, in particular, a particle size of the bulk goods, in the first and/or second recording.

The reference object may be used to determine dimensions of structures contained in the first and/or second recording if the dimensions of the reference object are known.

The reference object may represent a base or parts thereof on which bulk goods can be piled up. For example, the reference object has a pattern, such as a checkerboard pattern. This is advantageous because a length reference is obtained using the reference object even if areas of the reference object (e.g., by bulk goods) are obscured.

The reference object may, for example, have a rectangular main side and preferably be a planar and/or plate-shaped element. Such a reference object may be placed or positioned appropriately next to the bulk goods sample during the recording. The reference object may have a black or white side. This is advantageous because it also provides a color reference.

The reference object may also advantageously provide information for an ML model, discussed in detail below, as to which ML model is used to evaluate the first and/or second recording. In this case, the ML model may, for example, learn a relationship between the reference object and a particle size of the bulk goods. Therefore, the reference object may also be included in the recordings used to train the ML model.

The determined configuration can comprise information about a model type from a selection of several model types of metering devices, about a discharge element from a selection of several discharge elements for metering devices, and/or about settings of at least one operating parameter for metering devices from a selection of several operating parameters.

The metering device advantageously has a discharge element. The discharge element may be, for example, a screw conveyor, a conveyor belt, a plate conveyor, a spiral feeder, a screw, and/or a slide. The selection of discharge elements for metering devices therefore preferably includes the following discharge elements: screw conveyor, conveyor belt, plate conveyor, spiral feeder, screw, and/or slide. The selection of operating parameters for metering devices may include, for example: speed of the discharge element and/or operating temperature.

The first recording can be an image recording in the visible, infrared, or ultraviolet spectral range, retrieved from a memory, received by a sensor, in particular, an optical sensor, and/or received via a data connection.

The first recording may be taken with a camera. This may, for example, have a sensor that is sensitive in the visible, infrared, and/or ultraviolet spectral range. By choosing the sensor type, i.e. which spectral components of the light are recorded for the recording, different features can be determined directly based on the data from the first recording.

For example, an infrared camera can be used to determine the temperature of the bulk goods, and the configuration of the metering device for metering these bulk goods can be determined based on that temperature. For example, a heating of the metered bulk goods above a threshold value may be detected when the method is applied during operation of the metering device. An increased temperature may indicate an incorrect selection of the discharge element in the metering device, and thus an unsuitable configuration. The metering process of the bulk goods may then, for example, be aborted in response to that detection.

Furthermore, the first recording can also be taken using a radar sensor and/or an X-ray device.

The first recording of the bulk goods to be metered may be made, for example, before the metering device is filled with the bulk goods to be metered. For example, the bulk goods captured by the first recording may be contained in a sealed material packaging. For example, the bulk goods captured in the first recording may be located in the inlet of the metering device and/or in a storage container from which the bulk goods are taken and fed to the metering device. In one embodiment, the bulk goods captured by the first recording are located outside the metering device, inside the metering device, and/or in front of and/or behind the discharge device.

The second recording can be an image recording, preferably in the visible, infrared, or ultraviolet spectral range, retrieved from a memory, received from a sensor, in particular, an optical sensor, and/or received via a data connection.

The second recording may advantageously be taken with a camera. This may, for example, have a sensor that is sensitive in the visible, infrared, and/or ultraviolet spectral range. By choosing the sensor type, i.e. which spectral components of the light are recorded for the image, different features may advantageously be determined directly based on the data of the second recording.

For example, an infrared camera may be used to determine the temperature of the bulk goods, and the configuration of the metering device for metering these bulk goods may be determined based at least partly on the temperature. For example, a heating of the metered bulk goods above a threshold value may be detected when the method is applied during operation of the metering device. An increased temperature may indicate an incorrect selection of the discharge element in the metering device, and thus an unsuitable configuration. The metering process of the bulk goods may then, for example, be aborted in response to that detection.

Furthermore, the second recording may also be taken using a radar sensor and/or an X-ray device.

The second recording of the bulk goods to be metered may be taken, for example, before the metering device is filled with the bulk goods to be metered. For example, the bulk goods captured by the second recording may be located in a preferably sealed material packaging. For example, the bulk goods captured by the second recording may be located in the inlet of the metering device and/or in a storage container from which the bulk goods are advantageously removed and fed to the metering device. In one embodiment, the bulk goods captured by the second recording may be located outside the metering device, inside the metering device, and/or in front of and/or behind the discharge device.

The suggestion module may also include an ML model that has been pre-trained and/or is included in the configuration determination.

Advantageously, the machine learning model (ML model) is trained with data from a plurality of recordings of one or more known bulk goods. In this way, a relationship between, on the one hand, a recording (of bulk goods) and, on the other hand, a specific bulk goods or information about it (such as an identifier and/or a property of the bulk goods) and/or a configuration of a metering device can be learned. Optionally, in addition to the recording data, further information, such as information about metering devices (in particular, their configuration), can be provided as input data, and the training may take this information into account accordingly. This allows the learned context to be expanded.

The ML model preferably has, at least in part, the input data and output data of the suggestion module as input data and output data. The ML model therefore advantageously calculates the output data based on the input data. Accordingly, the ML model is advantageously trained on input data that corresponds to the input data used later.

The ML model may also have learned a relationship between identifiers (of bulk goods) on the one hand and configurations on the other. Optionally, further information, such as data on metering devices (especially on their configuration), can be provided as input data, and the training can take this information into account accordingly. This allows the learned context to be expanded.

To extract information from images, convolutional neural networks (CNN), especially, deep learning models, have proven to be advantageous and are therefore preferred as the basis for the first ML model.

The first ML model can also be retrained using later newly recorded images. This allows the reliability and quality of the determined configuration to be continuously enhanced.

The first evaluation module can have an ML model that has been pre-trained and/or is included in the determination of the first and/or second bulk goods property and/or the identifier.

The second evaluation module can have an ML model that has been pre-trained and/or is included in the determination of the second bulk goods property.

Advantageously, the machine learning model (ML model) of the first and/or second evaluation module can be trained with data from a large number of recordings of one or more known bulk goods. In this way, a relationship can be learned between a recording (of bulk goods), on the one hand, and specific bulk goods or information about it (such as an identifier or a property of the bulk goods), on the other hand. Optionally, the relationship with different sample configurations can also be learned.

Advantageously, an ML model can be used both in the suggestion module and in the first and second evaluation modules, wherein the ML models are independent. In this case, it is advantageous if the ML model of the suggestion module is trained with data that results from the output of the ML model of the first and/or second evaluation module and/or that is determined based on the result data of the ML model of the first and/or second evaluation module. This way, the ML model of the suggestion module can learn a relationship between the respective output data of the first and/or second evaluation module (as well as any additional information), on the one hand, and a configuration, on the other hand.

If the ML models exist, a configuration can therefore advantageously be determined using the ML model of the suggestion module based on the result data of the ML model of the first and/or second evaluation module and/or the information determined based on the result data of the ML model of the first and/or second evaluation module.

Convolutional neural networks (CNN), particularly in the field of deep learning, have proven to be advantageous for extracting information from images and are therefore preferably used as the basis for the ML model of the first and/or second evaluation module.

The ML model of the first and/or second evaluation module can also be retrained with subsequently newly recorded images. This allows the reliability and quality of the determined configuration to be continuously enhanced.

The ML model of the respective evaluation module preferably can have, at least in part, the input data and output data of the respective evaluation module as input data and output data. The respective ML model therefore advantageously calculates the output data based on the input data. Accordingly, the ML model is advantageously trained on input data that corresponds to the input data used later.

The first bulk goods property can be at least one of the following properties of the bulk goods or a measure thereof: A grain shape, a grain size, a particle size, an angle of repose, an angle of discharge, a physical property, a chemical property, a moisture content, a material type, a density, a flow behavior, a tendency to bridge formation, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness, and/or a stickiness.

The second bulk goods property can be or characterizes a haptic material property of the bulk goods or is at least one of the following properties of the bulk goods or a measure thereof: A grain shape, a grain size, a particle size, an angle of repose, an angle of discharge, a physical property, a chemical property, a moisture content, a material type, a density, a flow behavior, a tendency to bridge formation, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness, and/or a stickiness.

Further information on bulk goods properties (in particular on material properties of bulk goods) may be found, for example, in the document “General properties of bulk materials and their symbolization” of the “FÉDÉRATION EUROPÉENNE DE LA MANUTENTION SECTION II”, FEM 2 582, Original D, Edition D, November 1991, the document “Specific bulk material properties in mechanical conveying” of the “FÉDÉRATION EUROPÉENNE DE LA MANUTENTION SECTION II”, FEM 2 181, Original E, Edition D, 1989, and the document “Properties of bulk materials” of the “FÉDÉRATION EUROPÉENNE DE LA MANUTENTION SECTION II”, FEM 2 581, Original D, Edition D, November 1991.

The metering parameter can be a feed rate, in particular, a target, minimum, maximum, and/or average feed rate, of the metering device and/or is obtained via a user interface.

The feed rate of a metering device with respect to bulk goods can be the quantity (in kilograms or in liters) of the bulk goods that can be metered per unit of time with the metering device.

The object is achieved by the invention according to a second aspect in that a method for obtaining a recommendation for a configuration of a metering device for bulk goods to be metered, wherein a first recording of a sample of the bulk goods is taken, in particular, in a first sample configuration and/or with a camera, and/or a second recording of the sample of the bulk goods, in particular, in a second sample configuration and/or with a camera, is taken and provided in a method according to the first aspect of the invention and is obtained there as a first recording and/or second recording.

This makes it particularly advantageous to obtain a suitable configuration of a metering device against the background of bulk goods to be metered.

The camera used to take the first and second recordings may be the same camera or two different cameras.

In particular, the method in which the recordings are provided may also be carried out at a remote location, such as on a cloud computer. Thus, only a camera and a corresponding data connection must be provided on the client side in order to be able to use a method according to the second aspect of the invention.

For example, the method may be executed using a smartphone. This enables mobile determination of configurations of bulk goods metering devices by operating personnel.

Preferably, the method is computer-implemented.

All advantages described with respect to the method according to the first aspect of the invention also apply accordingly to the method according to the second aspect of the invention. Therefore, reference may be made to the previous statements at this point.

Alternatively or additionally, it can also be provided that the method comprises (i) that the configuration determined in the method according to the first aspect of the invention is obtained as a recommendation for a configuration and/or that the control signal generated in the method according to the first aspect of the invention is obtained, (ii) that a property, in particular a material property, for example, a haptic material property, of the bulk goods is determined, in particular manually, and provided in the method according to the first aspect of the invention and obtained there as a data set representing a second bulk goods property, and/or (iii) that at least one parameter is provided in the method according to the first aspect of the invention and obtained there as a metering parameter.

For example, the obtained configuration may be displayed on a user interface, such as a screen, and/or stored in a database.

By providing the method with further information about the bulk goods, such as material properties, and/or the metering device, such as metering parameters, a better recommendation for a configuration can be obtained.

The object is also achieved by the invention according to a third aspect in that a device for data processing comprising that are configured to carry out a method according to the first aspect of the invention and/or according to the second aspect of the invention, is proposed.

The device for data processing may comprise the suggestion module, the first evaluation module, and/or the second evaluation module and/or be operatively connected to these.

All advantages and options explained with respect to the method according to the first and/or second aspect of the invention also apply accordingly to a device for data processing according to the third aspect of the invention. Therefore, reference can be made to the previous statements in this regard.

For example, the device for data processing is a cloud computer system. The device for data processing may comprise or represent a distributed system.

The object is achieved by the invention according to a fourth aspect in that a metering device, which comprises a device for data processing according to the third aspect of the invention and/or is operatively connected thereto, is proposed.

Such a metering device makes it particularly advantageous to continuously compare the current configuration of the metering device with the proposed configuration during the operation of the metering device and, if necessary, to make adjustments to the current configuration of the metering device and/or to abort an ongoing metering process and/or not to start a new metering process.

All advantages and options explained with regard to the method according to the first aspect of the invention and with regard to the device for data processing according to the third aspect of the invention also apply accordingly to a metering device according to the fourth aspect of the invention. Therefore, reference can be made to the previous statements in this regard.

The object is achieved by the invention according to a fifth aspect in that a device for data processing, in particular a smartphone, with a camera and further means which are designed to provide images taken with the camera in a method according to the first aspect of the invention in such a way that they are obtained there as a first recording and/or as a second recording, is proposed.

The smartphone may comprise a screen to provide recommendations for configurations of metering devices. The device for data processing can be used to carry out a method according to the second aspect of the invention.

All advantages and options explained with respect to the method according to the second aspect of the invention also apply equally to the device for data processing according to the fifth aspect of the invention. Therefore, reference can be made to the previous statements in this regard.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a metering device known from the prior art;

FIG. 2a is a first recording of a sample of bulk goods in a first sample configuration;

FIG. 2b is a second recording of the bulk goods sample from FIG. 2a in a second sample configuration;

FIG. 3 is a flowchart of a method according to the first aspect of the invention in a first embodiment;

FIG. 4 is a flowchart of a method according to the first aspect of the invention in a second embodiment;

FIG. 5 is a flowchart of a method according to the first aspect of the invention in a third embodiment;

FIG. 6 is a flowchart of a method according to the first aspect of the invention in a fourth embodiment;

FIG. 7 is a flowchart of a method according to the second aspect of the invention;

FIG. 8 is a schematic representation of a device for data processing according to the third aspect of the invention;

FIG. 9 is a schematic representation of a metering device according to the fourth aspect of the invention; and

FIG. 10 is a schematic representation of a device for data processing according to the fifth aspect of the invention.

### DETAILED DESCRIPTION

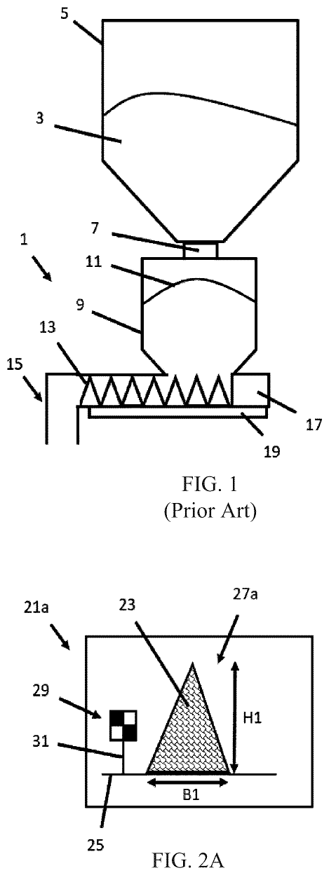

FIG. 1 shows a schematic representation of a metering device 1 known from the prior art.

Bulk goods 3 to be metered are fed to the metering device 1 from a storage container 5. From the storage container 5, the bulk goods pass via a selectively openable and closable connecting section 7 into a receiving container 9 of the metering device 1, in which it is present as a bulk goods quantity with a surface 11. By opening the connecting section 7, bulk goods can be transferred from the storage container 5 into the receiving container 9. Via a discharge element 13, the bulk goods 3 are then discharged in a manner known per se from the metering device 1, i.e. from the receiving container 9, and leaves the latter via a vertical discharge 15. The discharge element 13 is coupled to a motor 17 and can be rotated at an adjustable, variable speed, controlled by a motor controller of the motor 17. During the material discharge, a change in the weight of a system of the metering device 1 weighed by a load cell 19 is used to control the speed of the discharge element 13. The metering device described is a so-called “loss-in-weight metering scale”. The discharge device 13 may be provided as a screw, conveyor belt, or vibrating chute.

In order to meter the bulk goods 3 with the metering device 1, the metering device 1 must be configured appropriately. This means that the appropriate type of metering device and the appropriate components must first be selected. For this purpose, a method according to the first aspect of the invention, with which a type of metering device and a configuration of the metering device 1 can be determined, may be advantageously used.

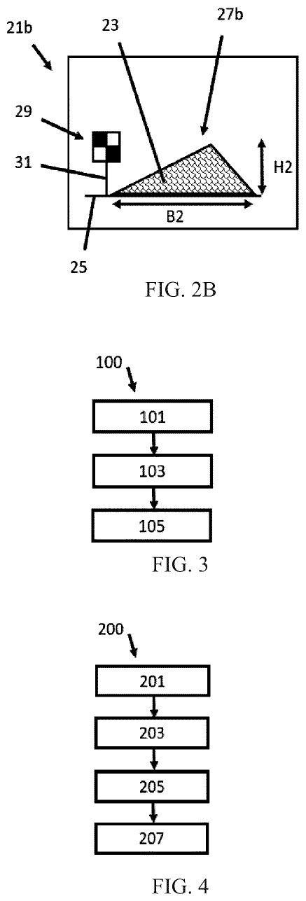

FIG. 2a shows a first recording 21a of a sample 23 of bulk goods to be metered with the metering device 1, in which the sample 23 is in a first sample configuration. To set the first sample configuration, the bulk goods sample 23 was piled up from a defined height (for example, 40 cm) onto a base 25.

FIG. 2b shows a second recording 21b of the bulk goods sample 23, in which the sample 23 is in a second sample configuration. The bulk goods sample 23 was transferred from the first to the second sample configuration by piling the bulk goods sample 23 again from a defined different height (for example, 80 cm) onto the base 25.

Both recordings are taken from the side with identical perspective. The sample configurations shown are two differently formed heaps 27a, 27b of the same bulk goods sample 23. Due to properties, in particular material properties, of the bulk goods of sample 23, the two differently formed heaps 27a, 27b with different heights H1 and H2 and different widths B1 and B2 result for the two different discharge heights, which are illustrated in the two recordings by labeled double-headed arrows.

In both recordings 21a, 21b a reference object 29 can also be seen. The reference object 29 is plate-shaped and is fastened to a holder 31 in such a way that the main side of the reference object 29 is captured frontally in the recordings 21a, 21b. The dimensions of reference object 29 and the checkerboard pattern on reference object 29 are known. Thus, the reference object 29 can be used to determine a distance, for example, a dimension of a structure of the bulk goods, in the respective recording 21a, 21b.

FIG. 3 shows a flowchart 100 of a method according to the first aspect of the invention in a first embodiment.

In 101, the first recording 21a is obtained, which is the recording 21a of the sample 23 of the bulk goods to be metered with the metering device 1 in a first sample configuration. For this purpose, the data of the recording 21a is received, for example, via a data line or retrieved from a memory.

In 103, based on this data of the first recording 21a, the type of metering device 1 and its configuration for the bulk goods of the sample 23 are determined. For this purpose, the image data is processed using a suggestion module. The suggestion module is actually a machine learning (ML) model that has learned types of metering devices and corresponding configurations of metering devices during training based on numerous recordings of different bulk goods with selected device type and configuration of a metering device. (The recordings used for training each show a sample of the bulk goods in a sample configuration as described in FIG. 2a, including the correspondingly placed reference object). The obtained image data is therefore fed to the suggestion module and thus to the ML model, and the ML model is calculated using this image data. This results in output data at the output of the ML model that represents the configuration of the metering device 1.

In 105, the determined configuration is output to a user on a user interface, such as a screen, and/or stored in a database.

Based on the data of the first recording 21a, the configuration of the metering device 1 for the bulk goods is determined.

FIG. 4 shows a flowchart 200 of a method according to the first aspect of the invention in a second embodiment.

In 201, the first recording 21a is obtained, which is the recording 21a of the sample 23 of the bulk goods to be metered with the metering device 1 in a first sample configuration. For this purpose, the data of the recording 21a is received, for example, via a data line or retrieved from a memory.

In 203, the second recording 21b is obtained, which is the recording 21b of the sample 23 of the bulk goods to be metered with the metering device in a second sample configuration. For this purpose, the data of the recording 21b is received, for example, via a data line or retrieved from a memory.

In 205, based on the data of the first and second recordings 21a, 21b, the type of metering device 1 and the configuration of the metering device 1 for the bulk goods of the sample 23 are determined. For this purpose, the image data is processed using a suggestion module. The suggestion module is, strictly speaking, a machine learning (ML) model that has learned, during training, types of metering devices and corresponding configurations of metering devices based on numerous pairs of first and second recordings of different bulk materials (wherein the respective recordings of the respective sample of the bulk goods are in the first and second sample configurations described above) with an associated selection of the type and corresponding configuration of a metering device. (The recordings used for training also show the correspondingly placed reference object 29). The obtained image data is therefore fed to the suggestion module and thus to the ML model, and the ML model is calculated using this image data. The output of the ML model then produces output data that represent the type and the corresponding configuration of the metering device 1.

In 207, the determined configuration is output to a user on a user interface, such as a screen, and/or stored in a database.

Based on the data of the first and second recordings 21a, 21b, the configuration of the metering device 1 for the bulk goods is determined.

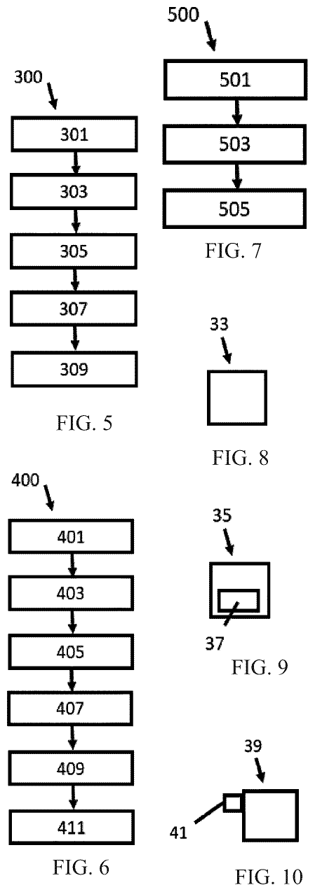

FIG. 5 shows a flowchart 300 of a method according to the first aspect of the invention in a third embodiment.

In 301, the first recording 21a is obtained, which is again the recording 21a of the sample 23 of the bulk goods to be metered with the metering device 1 in a first sample configuration. For this purpose, the data of the recording 21a is received, for example, via a data line or retrieved from a memory.

In 303 the image data is processed with a first evaluation module. The first evaluation module is actually a machine learning model (ML model) that has learned bulk goods properties during training based on numerous recordings of different bulk goods with assigned properties. (The recordings used for training each show a sample of the bulk goods in a sample configuration as described in FIG. 2a, including the correspondingly placed reference object 29). The obtained image data is therefore fed to the first evaluation module, and thus to the ML model, and the ML model is calculated on this image data. The output of the ML model then produces output data that represents a first property of the bulk goods. This is a material property of the bulk goods.

In 305, a data set representing a second property of the bulk goods is obtained via user input. This is another material property of the bulk goods. Optionally, a metering parameter is also obtained, for example, via user input. As a metering parameter, for example, a required minimum feed rate that is required in the planned application scenario can be specified.

In 307, the first property, the second property, and optionally also the metering parameter are processed via a suggestion module in order to determine the type of metering device and the configuration of the metering device for the bulk goods of the sample. The suggestion module is actually a machine learning (ML) model that has learned configurations of metering devices during training based on numerous different combinations of the first property, the second property, and, optionally, metering parameters with an associated configuration of a metering device. The data (i.e. first property, second property, and optionally also metering parameters) are therefore fed to the suggestion module, and thus to the ML model, and the ML model is calculated based on this data. The ML model then produces output data that represents the type and configuration of the metering device. Additional data can also be provided as input data to the ML model, although this is not necessary in this case.

In 309, the determined configuration is output to a user on a user interface, such as a screen, and/or stored in a database.

For example, the second property is a material property of the bulk goods that was not determined from the recording or possibly cannot be determined at all.

Based on the data from the first recording 21a, the amount of data and, if applicable, the metering parameters, the type, and configuration of the metering device 1 for the bulk goods is determined.

In this case, the data of the first recording 21a is not processed directly with the data set and the metering parameter, but the first bulk goods property determined on the basis of the data of the first recording 21a is then processed together with the second bulk goods property and, if applicable, the metering parameter by feeding this data to the ML model of the suggestion module as input data.

FIG. 6 shows a flowchart 400 of a method according to the first aspect of the invention in a fourth embodiment.

401 and 403 are very similar to 301 and 303, but in 403 the ML model of the first evaluation module has not learned bulk goods properties (like the ML model in 303) during training, but bulk goods identifiers based on numerous recordings of different bulk materials with assigned identifiers. (The recordings used for training each show a sample of the bulk goods in a sample configuration as described in FIG. 2a, including the correspondingly placed reference object 29). The obtained image data is therefore fed to the first evaluation module, and thus to the ML model, and the ML model is calculated on this image data. This results in output data at the output of the ML model that represents an identifier of the bulk goods. This is an alphanumeric character string that identifies the bulk goods, for example, within an ERP database.

In 405, a first property, in particular a material property, of the bulk goods is retrieved from a database using the identifier.

In 407 (similar to optional in 305) a metering parameter is obtained, for example, via a user input. As a metering parameter, for example, a required minimum feed rate that is required in the planned application scenario can be specified. Alternatively, the metering parameter could also be queried from the database together with the first property of the bulk goods, where it could also be stored for the respective bulk goods.

In 409, the first property and the metering parameter are processed via a suggestion module to determine the configuration of the metering device for the bulk goods of the sample. The suggestion module is actually a machine learning (ML) model that has learned configurations of metering devices during training based on numerous different combinations of the first property and metering parameters with an associated configuration of a metering device. The data (i.e. first property and metering parameters) is therefore fed to the suggestion module and thus to the ML model, and the ML model is calculated based on this data. The output of the ML model then produces output data that represents the configuration of the metering device. Additional data can also be provided as input data to the ML model, although this is not necessary in this case.

In 411, the determined configuration is output to a user on a user interface, such as a screen, and/or stored in a database.

Based on the data of the first recording 21a and the metering parameter, the configuration of the metering device 1 for the bulk goods is determined. The data of the first recording 21a is not processed directly with the metering parameter; instead, an identifier determined from the data of the first recording enables obtaining the first bulk goods property. This first bulk goods property is then processed together with the metering parameter by feeding this data to the ML model of the suggestion module as input data.

In each of the above-explained embodiments of the method according to the first aspect of the invention, a type of metering device and the corresponding configuration of the metering device can thus be determined by, for example, specifying a discharge element and/or an operating parameter of the metering device 1 in the form of a maximum speed of the motor. For example, according to the determined configuration, the discharge element can be a screw and the maximum speed can be 60 revolutions per minute.

It should be noted that through the reference object 29, the ML model can also inherently learn and exploit a relationship between bulk goods parts and the reference object, which can lead to better configuration recommendations. However, in alternative embodiments, it is possible that no reference object is placed in the recordings (both those obtained in the method and those used to train the respective ML model).

FIG. 7 shows a flowchart 500 of a method according to the second aspect of the invention. With this method, a recommendation for a type of metering device and a corresponding configuration of the metering device 1 for bulk goods to be metered can be obtained.

In 501, a first recording of a sample of the bulk goods in a first sample configuration is taken with a camera (this is, for example, the first recording 21a from FIG. 2a) and/or a second recording of the sample of the bulk goods in a second sample configuration is taken with the camera (this is, for example, the second recording 21b from FIG. 2b). The reference object 29 can also be provided accordingly in the recording.

In 503, the first recording or the two recordings (in particular, their image data) are provided in a method according to the first aspect of the invention and are received there as the first recording and/or the second recording. For example, this could be a method as described in relation to FIGS. 3 to 6.

In 505, a configuration is obtained as a recommendation for a type of metering device and a corresponding configuration of the metering device 1 for the bulk goods to be metered.

With the help of the configuration recommendation, the metering device 1 can be easily configured to suit the bulk goods to be metered. The method to which the image data is provided can advantageously be executed on a cloud server.

FIG. 8 shows a schematic representation of a data processing device 33 according to the third aspect of the invention.

The data processing device 33 comprises means configured to carry out a method according to the first and/or second aspect of the invention.

FIG. 9 shows a schematic representation of a metering device 35 according to the fourth aspect of the invention.

The metering device 35 may be the metering device of FIG. 1 with a data processing device 37 according to the third aspect of the invention, such as the device 33 as described with reference to FIG. 8.

FIG. 10 shows a schematic representation of a device for data processing 39 according to the fifth aspect of the invention.

The data processing device 39 is a smartphone with a camera 41. The device 39 offers the operating personnel of the metering device 1 a flexible possibility to determine a suitable configuration for the metering device 1, for example, for bulk goods 3 to be metered, before filling it into the storage container 5.

For this purpose, the data processing device 39 has means which are designed to provide images taken with the camera 41 (for example, the recordings 21a and/or 21b) in a method according to the first aspect of the invention in such a way that they are obtained there as a first recording and/or a second recording.

The features disclosed in the foregoing description, in the drawings and in the claims may be essential to the invention in its various embodiments, both individually and in any combination.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A method for providing a metering device for bulk goods to be metered, the method comprising:
obtaining at least a first recording of at least one sample of the bulk goods; and determining, based on the data of the first recording, at least one type of metering device and a corresponding configuration of the metering device for the bulk goods.

2. The method according to claim 1, wherein the method comprises that via a suggestion module the one type of metering device and the corresponding configuration of the metering device for the bulk goods are determined, wherein the data of the first recording is included in the determination of the type and the configuration via the suggestion module and/or that via a first evaluation module a first identifier of the bulk goods is determined based on the data of the first recording, and wherein the first identifier is included in the determination of the configuration via the suggestion module.

3. The method according to claim 2, wherein the method further comprises retrieving information relating to the associated bulk goods from a database based on the identifier and including said information in determining the configuration via the suggestion module.

4. The method according to claim 1, wherein the method further comprises obtaining at least one data set representing a second identifier of the bulk goods,
wherein (i) based on the received data set, the type and the corresponding configuration of a metering device for the bulk goods is determined via the suggestion module and/or (ii) the data sct is taken into account in determining the type and the corresponding configuration.

5. The method according to claim 1, wherein the method further comprises obtaining a second image of the sample of the bulk goods, and
wherein (i) the type and corresponding configuration of a metering device for the bulk goods is determined via the suggestion module, taking into account the data from the second recording, and/or (ii) the data from the second recording is included in the determination of the type and the corresponding configuration of the metering device,
wherein (i) the first identifier of the bulk goods is determined via the first evaluation module on the basis of the data of the first and second recording, and/or (ii) a second identifier of the bulk goods is determined via a second evaluation module on the basis of the data of the first and/or second recording and is included in the determination of the configuration.

6. The method according to claim 5, wherein (i) the first recording and the second recording are carried out from different perspectives and/or (ii) the bulk goods sample is in a first sample configuration in the first recording and the bulk goods sample is in a second sample configuration in the second recording, wherein preferably between the two recordings the bulk goods sample is transferred from the first sample configuration to the second sample configuration, and
wherein the first and second sample configurations are two differently formed heaps of the bulk goods sample and/or at least one parameter of the ambient conditions, such as ambient temperature, air humidity and/or ambient pressure, of the bulk goods sample is changed between the first and second sample configuration.

7. The method according to claim 1, wherein the method comprises that a metering parameter is obtained and, based on the metering parameter, the configuration of a metering device for the bulk goods is determined.

8. The method according to claim 1, wherein (i) type, configurations and status data of metering devices and/or bulk goods data relating to the bulk materials metered by the metering devices is obtained, in particular from a cloud-based computer, and is taken into account, in particular in the suggestion module, when determining the type and configuration, wherein a provisionally determined configuration is validated on the basis of the received configurations, status data and/or bulk goods data and, preferably, if the provisionally determined configuration does not correspond to a defined quality standard, is adapted and/or (ii) the determined configuration is compared with a current configuration of a metering device, in particular, to be used for metering the bulk goods, and preferably, depending on the result of the comparison, a control signal is generated, which is preferably fed, in particular, as a control and/or regulating signal, to the metering device and/or to an entity, in particular, different from the metering device.

9. The method according to claim 1, wherein the first identifier for the bulk goods is at least one of the following properties of the bulk goods or a measure thereof: a grain shape, a grain size, a particle size, an angle of repose, an angle of discharge, a physical property, a chemical property, a moisture content, a material type, a density, a flow behavior, a tendency to bridge, a tendency to shoot when fluidized, a clumping content, an electrostatic chargeability, a chemical instability, a temperature sensitivity, suspended in air, a tendency to segregate, consisting of components, a free flow, a tendency to agglomeratc, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness and/or a stickiness, and/or wherein the second identifier of the bulk goods is or characterizes a haptic material property of the bulk goods or is at least one of the following properties of the bulk goods or a measure thereof: a grain shape, a grain size, a particle size, an angle of repose, an angle of discharge, a physical property, a chemical property, a moisture content, a material type, a density, a flow behavior, a tendency to bridge formation, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness, and/or a stickiness.

10. A method for obtaining a recommendation for a configuration of a metering device for bulk goods to be metered, comprising that a first image of a sample of the bulk goods, in particular, in a first sample configuration and/or with a camera, is taken and/or a second image of the sample of the bulk goods, in particular, in a second sample configuration and/or with a camera, is taken and provided in a method according to claim 1 and is obtained there as a first recording and/or second recording.

11. The method according to claim 10, wherein the method comprises (i) that the configuration determined is obtained as a recommendation for a configuration and/or that the control signal generated is obtained, (ii) that a property, in particular, a material property, for example, a haptic material property, of the bulk goods is determined, in particular, manually, and provided and obtained there as a data set representing a second bulk goods property and/or (iii) that at least one parameter is provided and obtained there as a metering parameter.

12. A device for data processing adapted to carry out the method according to claim 1.

13. The device for data processing according to claim 12, wherein the device is a handheld computer or a smartphone with a camera designed to provide images taken with the camera such that they are obtained there as a first recording and/or as a second recording.
